(19) United States
(12) Patent Application Publication
(10) Pub. No.: US 2010/0279806 A1
(43) Pub. Date: Nov. 4, 2010

(54) Transmission structure improvement for bending tail pipe

(76) Inventor: Aling Lai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,960

(22) Filed: Jan. 3, 2008

(51) Int. Cl. F16H 7/00

(52) U.S. Cl. 474/150

(57) ABSTRACT

A transmission structure improvement for bending a tail pipe includes a main body, having a containing space, and an opening is disposed at the main body, such that the containing space communicates with the exterior of the main body through the opening, and one end of the main body has a first attachment end and the other end has a second attachment end, and the second attachment end bends at a bend angle relative to the first attachment end and a plurality of first connecting portions are disposed at the main body; a side panel, having a plurality of second connecting portions, and the second connecting portions and the first connecting portions correspond to and are engaged with each other, such that the side panel is mounted at the opening.

### FIELD OF THE INVENTION

The present invention relates to a tail rotor transmission structure of a model helicopter, and more particularly to a transmission structure improvement for bending a tail pipe.

### BACKGROUND OF THE INVENTION

A usual model helicopter, as shown in FIG. 6, is mainly composed of a body, a main rotor set 2, a tail pipe 3 and a tail rotor set 4, wherein the body 1 has a transmission mechanism 5, the transmission mechanism 5 provided for driving the main rotor set 2 to operate, and the transmission mechanism 5 is equipped with a transmission belt 6, the transmission belt 6 linked to the tail rotor set 4 through the tail pipe 3. Thus, the main rotor set 2 is driven by the transmission mechanism 5 and begins to operate, such that the tail rotor set 4 would synchronously operate driven by the transmission belt 6. However, the main rotor set 2 and the tail rotor set 4 of such model helicopters are not located on the same horizontal plane that when the model helicopter flies, the thrust generated by the main rotor set 2 and the tail rotor set 4 is unbalanced. Therefore, this is bound to cause the yaw of the body in flight of a model helicopter.

In order to improve the yaw of the body in flight of the above model helicopter, the professional players would alter the tail rotor portion of the model helicopter by themselves. They mount an upwardly tilted tailstock on the tail pipe of the model helicopter, and then install the tail rotor set on the tailstock, such that the tail rotor set and the main rotor set are located on the same horizontal plane, whereby the thrust generated by the tail rotor set would be balanced off by the torsion generated by the main rotor set so as to avoid the yaw of the body in flight of a model helicopter. Nevertheless, since the tailstock is made by jointing together a left and right cover plates in way of such self-alteration, the fact that the cover plates are unable to be fixed in advance would leads to the difficulty in assembly. If operators were inclined to adjust or replace the components of the transmission structure inside the tailstock, it would be very inconvenient due to the sagging and separation of the transmission structure inside the tailstock when the tailstock disassembled by the operators.

### SUMMARY OF THE INVENTION

The primary objective of the present invention is to provide a transmission structure improvement for bending a tail pipe, which has the advantage of rapid assembly.

The secondary objective of the present invention is to provide a transmission structure improvement for bending a tail pipe. When the operators intend to adjust or replace the transmission structure for bending a tail pipe, it is very simple and easy to do that.

To achieve the foregoing objectives, the present invention provides a transmission structure improvement for bending a tail pipe, which is installed at the tail pipe of a model helicopter, the transmission structure for bending a tail pipe comprising: a main body, having a containing space therein, a plurality of holders disposed in the containing space for installing a driving member, an opening disposed at the main body, such that the containing space communicates with the exterior of the main body through the opening, one end of the main body having a first attachment end and the other end having a second attachment end, and the second attachment end bending at a bend angle relative to the first attachment end and a plurality of first connecting portions disposed at the main body; and a side panel, having a plurality of second connecting portions, and the second connecting portions and the first connecting portions corresponding to and engaged with each other, such that the side panel is mounted at the opening.

### BRIEF DESCRIPTION OF THE DRAWINGS

FIG. 1 is a schematic pictorial view of the present invention.

FIG. 2 is a schematic plane view of the present invention.

FIG. 3 is a schematic diagram showing a service condition according to the present invention.

FIG. 4 is a schematic diagram showing another service condition according to the present invention.

FIG. 5 is a schematic diagram showing the assembly of the transmission structure of the present invention to a model helicopter.

FIG. 6 is a schematic diagram of a conventional model helicopter.

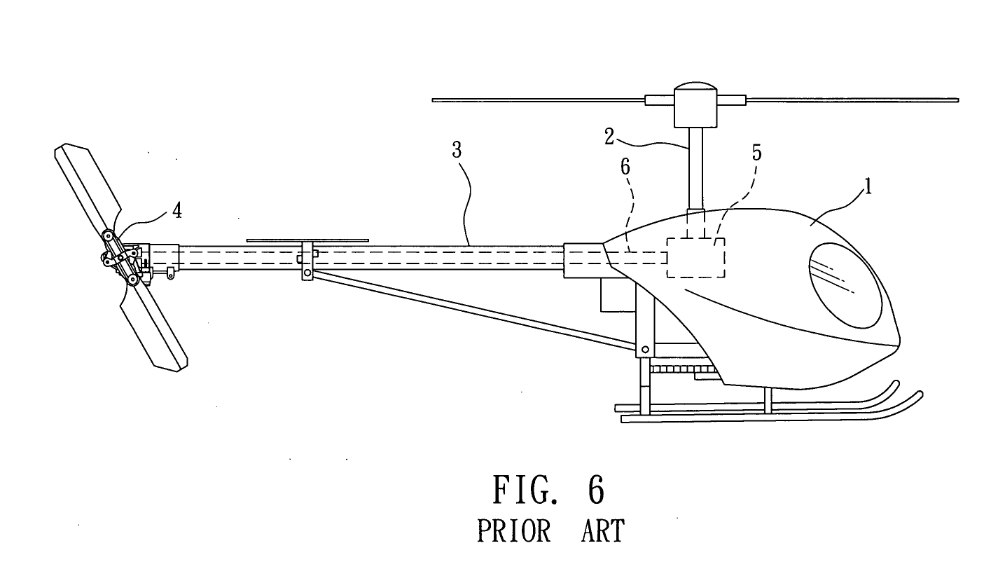

### DETAILED DESCRIPTION OF THE PREFERRED EMBODIMENTS

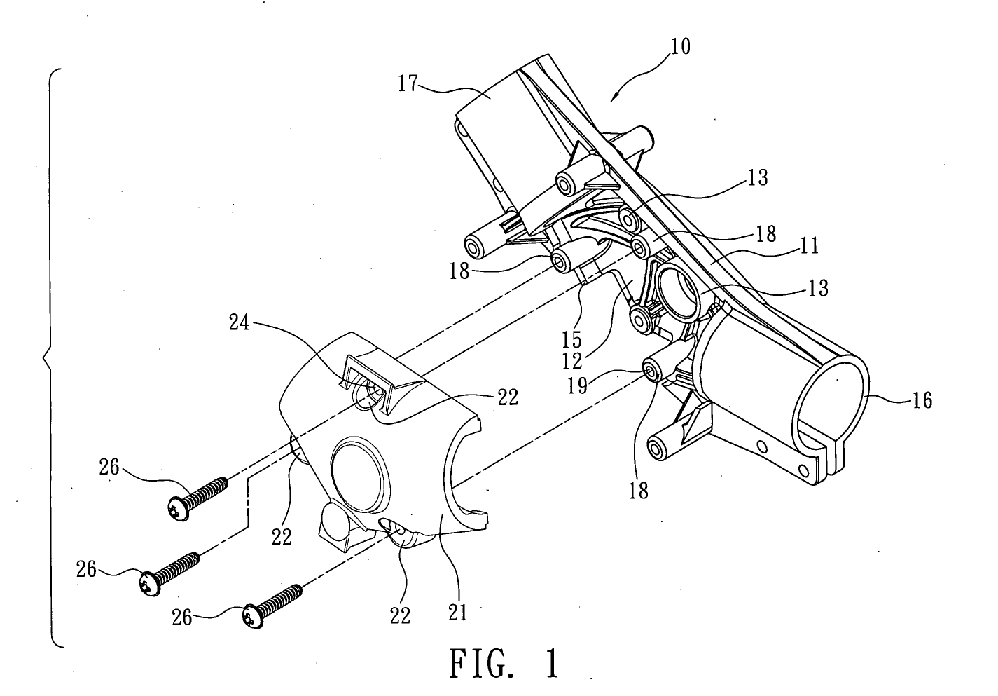

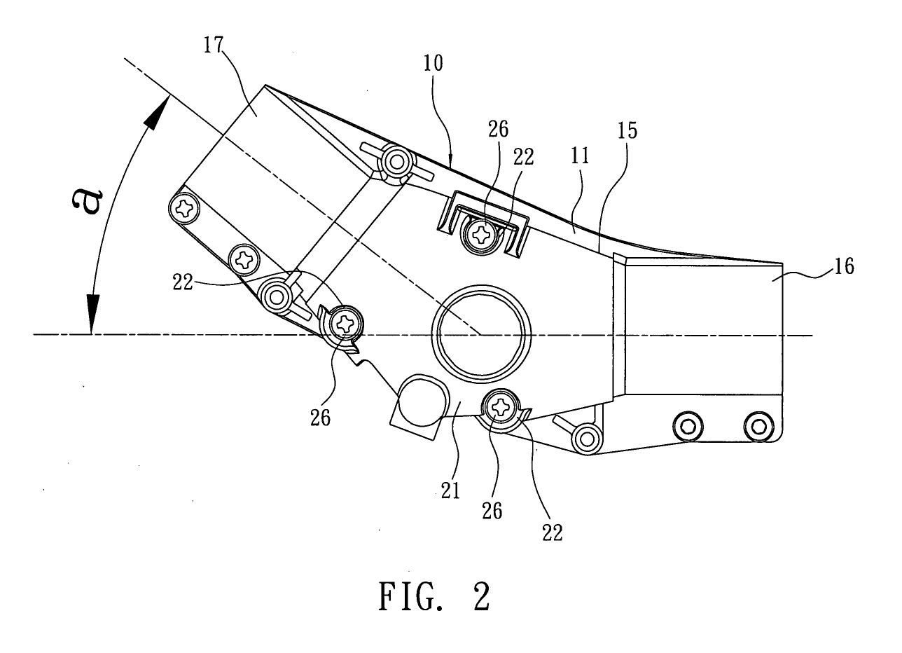

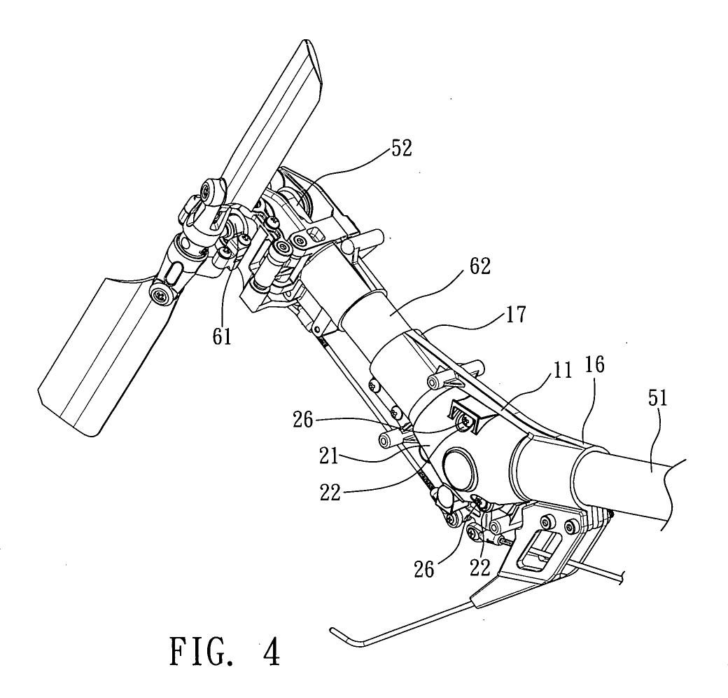

First of all, referring to FIGS. 1 to 5, the present invention provides a transmission structure improvement for bending a tail pipe, one end of the transmission structure coupled to the tail pipe 51 of a model helicopter 50, the other end coupled to the rod body 62 of a tail rotor set 61, and the transmission structure 10 for bending a tail pipe is mainly composed of a main body 11 and a side panel 21.

The main body 11 is a hollow shell structure, having a containing space 12 therein. Two holders 13 are convexly disposed in the containing space 12, and the holders 13 are provided for installing a driving member 14 (in this embodiment, it is a pulley structure) respectively. An opening 15 is disposed at the main body 11, such that the containing space 12 of the main body 11 communicates with the exterior of the main body 11 through the opening 15. One end of the main body 11 has a first attachment end 16 and the first attachment end 16 is tubular, such that the containing space 12 of the main body 11 communicates with the exterior space of the one end of the main body 11. The other end has a second attachment end 17 and the second attachment end 17 is tubular as same as the first attachment end, such that the containing space 12 of the main body 11 communicates with the exterior space of the other end of the main body 11. Besides, the second attachment end 17 bends at a bend angle a relative to the first attachment end 16, and three first connecting portions 18 are disposed in the containing space 12 of the main body 11, each of the first connecting portions 18 having a screw hole 19 respectively.

The side panel 21, whose contour corresponds to the shape of the opening 15 of the main body 11, such that the side panel 21 can precisely cover and match the opening 15 of the main body 11, and the side panel 21 has three second connecting portions 22. Each of the second connecting portions 22 is corresponsive with each of the first connecting portions 18 and has a through hole 24 respectively. After each of the first connecting portions 18 and each of the second connecting portions 22 correspond to and match each other, they are screwed and fixed by passing a screw 26 through the through hole 24 and the screw hole 19, such that the side panel 21 is mounted at the opening 15 of the main body 11.

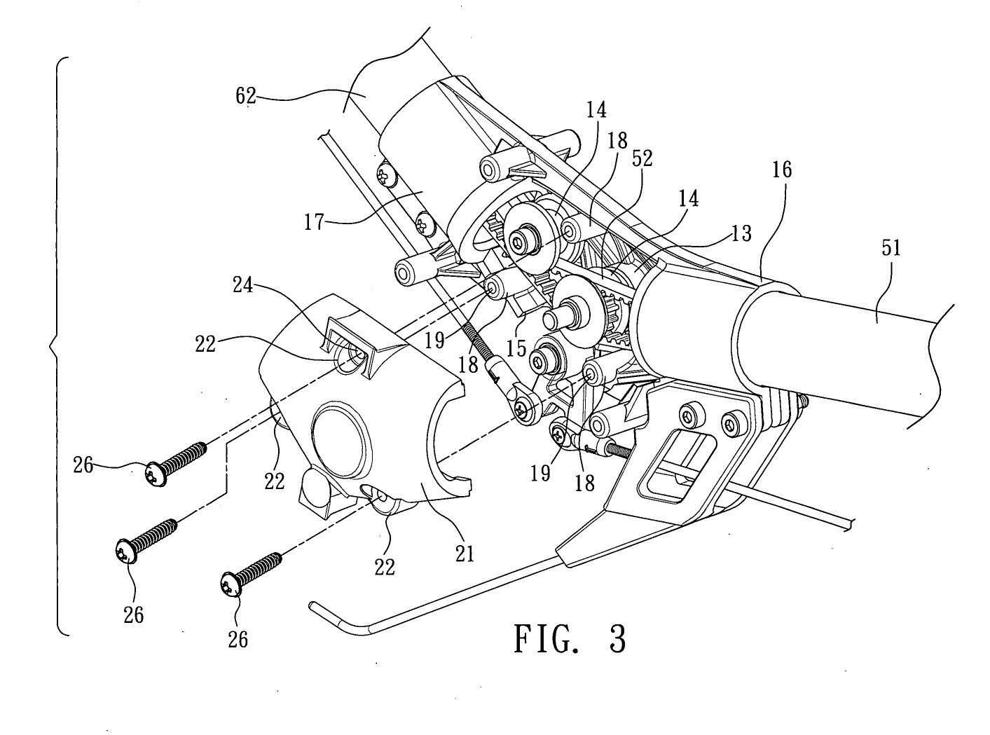

Next, referring to FIGS. 3 to 5, the transmission structure for bending a tail pipe according to the present invention is jointed to the tail pipe 51 of a model helicopter by the first attachment end 16, and the second attachment end 17 is to be jointed to the rod body 62 of a tail rotor set 61. The tail pipe 51 of the model helicopter is provided with a rotor transmission belt 52, and the transmission belt 52 initially passes through the first attachment end 16 of the main body 11, entering the containing space 12 of the main body 11, wrapping around the pulleys 14 and guided by the pulleys 14 and then derived from the second attachment end 17 to the exterior of the main body 11. Finally, the transmission belt 52 and the tail rotor set 61 are linked to each other to form the linkage of the entire transmission structure.

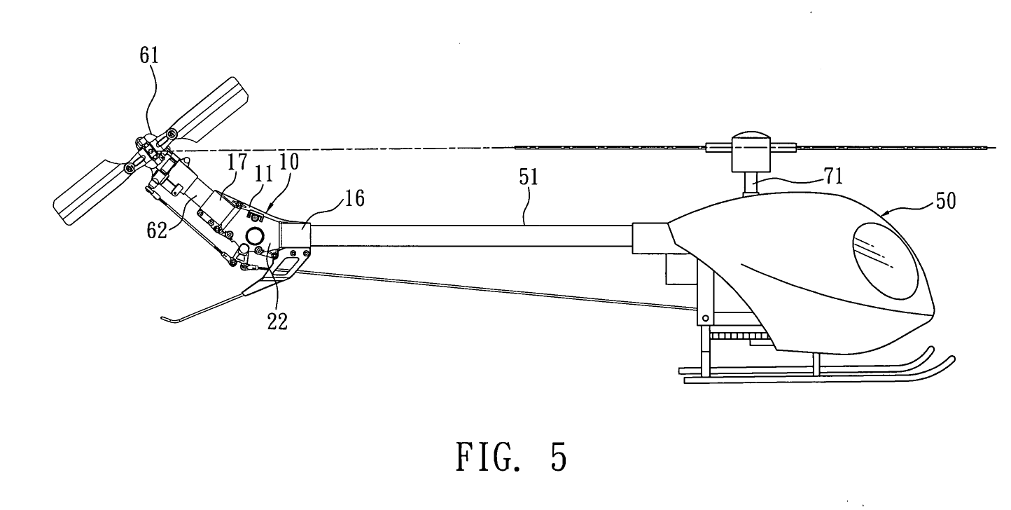

The second attachment end 17 has a bend angle a relative to the first attachment end 16, and therefore, when the transmission belt 52 passes through the tail pipe 51 entering the transmission structure 10 for bending a tail pipe according to the present invention, the transmission belt 52 is guided by the pulleys 14, such that the transmission belt 52 is bent upward and goes out of the second attachment end 17. Subsequently, the transmission belt 52 is further linked to the tail rotor set 61, whereby the tail rotor set 61 and the main rotor set 71 are located on the same horizontal plane, as shown in FIG. 5, and thus the yaw of the body in flight of a model helicopter can be improved. By means of the above transmission structure improvement for bending a tail pipe according to the present invention, the first attachment end 16 and the second attachment end 17 of the main body 11 are coupled to the tail pipe 51 and the rod body 62 of a tail rotor set 61 respectively when installed, so it is very rapid and easy in assembly. Furthermore, when the side panel 21 is detached, the driving members 14 would not fall off by themselves because the driving members 14 are mounted on the holders 13. When desired to adjust or replace the internal components of the transmission structure 10 for bending a tail pipe, it only needs to detach the side panel 21 from the opening 15 of the main body 11 in order to assemble or adjust the transmission belt 52 and the driving members 14. So, it is very convenient for use.

However, here it must be particularly specified that the driving member 14 described in the above embodiment is a pulley structure, but all the driving members should be considered as the equivalent embodiments of the present invention as long as the driving members 14 can bend the transmission belt 52 and never interfere with the operation of the transmission belt 52. Moreover, the manners of fixing the first connecting portions 18 of the main body 11 and the second connecting portions 22 of the side panel 21 are not limited to use of screws, all the fixing means such as catchings or others should also be considered as the equivalent embodiments of the present invention.

What is claimed is:

1. A transmission structure improvement for bending a tail pipe, which is installed at the tail pipe of a model helicopter, the transmission structure for bending a tail pipe comprising:
a main body, having a containing space therein, a plurality of holders disposed in the containing space for installing a driving member, an opening disposed at the main body, such that the containing space communicates with the exterior of the main body through the opening, one end of the main body having a first attachment end and the other end having a second attachment end, and the second attachment end bending at a bend angle relative to the first attachment end and a plurality of first connecting portions disposed at the main body; and
a side panel, having a plurality of second connecting portions, and the second connecting portions and the first connecting portions corresponding to and engaged with each other, such that the side panel is mounted at the opening.

2. The transmission structure improvement for bending a tail pipe as described in claim 1, wherein the model helicopter has a rotor transmission belt, and the belt passes through the first attachment end, guided by the driving member and then derived from the second attachment end.

3. The transmission structure improvement for bending a tail pipe as described in claim 2, wherein the driving member is a pulley.

4. The transmission structure improvement for bending a tail pipe as described in claim 1, wherein the first connecting portion of the main body has a screw hole and the second connecting portion of the side panel is a through hole, and the first connecting portion and the second connecting portion correspond to and match each other then screwed and fixed by a screw.

5. The transmission structure improvement for bending a tail pipe as described in claim 1, wherein the side panel contour corresponds to the shape of the opening of the main body, such that the side panel can precisely cover and match the opening of the main body.
